(19) United States
(12) Patent Application Publication
(10) Pub. No.: US 2016/0044325 A1
(43) Pub. Date: Feb. 11, 2016

(54) IMAGE CODING APPARATUS, IMAGE CODING METHOD AND IMAGING APPARATUS

(71) Applicant: FUJITSU LIMITED, Kawasaki-shi (JP)

(72) Inventors: Koji Kurihara, Kawasaki (JP); Kiyonori Morioka, Kawasaki (JP); Hidetoshi Matsumura, Kawasaki (JP); Noboru YONEOKA, Kawasaki (JP)

(73) Assignee: FUJITSU LIMITED, Kawasaki-shi (JP)

(21) Appl. No.: 14/887,446

(22) Filed: Oct. 20, 2015

Related U.S. Application Data
(63) Continuation of application No. PCT/JP2013/061908, filed on Apr. 23, 2013.

(51) Int. Cl. H04N 19/44; H04N 19/172; H04N 19/117

(52) U.S. Cl. CPC H04N 19/44; H04N 19/117; H04N 19/172

(57) ABSTRACT

An image coding apparatus includes a coding and decoding unit configured to selectively encode and decode pictures to be used as a reference among a predetermined number of pictures based on information for discriminating between pictures to be used as a reference and pictures not to be used as a reference, followed by encoding pictures not to be used as a reference among the predetermined number of pictures, an in-loop filter configured to perform filtering with respect to the pictures decoded by the coding and decoding unit, and a control unit configured to suspend power supply to the in-loop filter in response to timing at which the coding and decoding unit encodes the pictures not to be used as a reference.

### CROSS-REFERENCE TO RELATED APPLICATIONS

This application is a continuation application of International Application PCT/JP2013/061908 filed on Apr. 23, 2013 and designated the U.S., the entire contents of which are incorporated herein by reference.

### FIELD

The disclosures herein relate to an image coding apparatus, an image coding method and an imaging apparatus.

### BACKGROUND

Some products such as digital cameras utilize an image compression scheme such as H.264. An image compression scheme such as H.264 involves an in-loop filtering process. With respect to edge artifacts having a block shape that appear due to noise generated at block boundaries, the in-loop filtering process averages the values of neighboring pixels on both sides of an edge artifact, thereby making the edge artifacts less noticeable.

A device embedded in a digital camera, for example, operates with power supply from a battery, so that reduction in power consumption is of primary concern. When there is no need to perform the in-loop filtering process during the compression and coding process, clock gating may be used to lower the operating frequency of the in-loop filtering circuit, thereby reducing power consumption.

In general, reduction in power consumption by clock gating is less effective than reduction in energy consumption by power gating that can significantly reduce energy consumption caused by leakage. Suspension of power supply to a circuit by power gating, however, does not ensure that energy consumption caused by leakage is immediately reduced to zero. Even after the suspension of power supply, electric charge accumulated in parasitic capacitance and the like existing in the circuit continues to discharge through current-leakage paths. The amount of leak current thus exhibits a gradual decrease after the suspension of power supply. With the time length of power supply suspension being short, the time length in which a sufficient power gating effect is obtained (i.e., the period in which the leak current is nearly zero) is short. In this case, reduction in power consumption by power gating is not sufficiently effective.

When encoding a picture in an image compression and coding process such as H.264, an in-loop filtering process is not performed with respect to the picture if the picture is not referenced. In consideration of this, power supply to the in-loop filtering process may be suspended at the same timing as the encoding of a picture that is not referenced. It is generally not the case, however, that the in-loop filtering process is nonexistent for such a long time period as a sufficient power gating effect is obtained. Reduction in power consumption is thus not sufficiently obtained.

### RELATED-ART DOCUMENTS

[Patent Document 1] Japanese Laid-open Patent Publication No. 2006-67142
[Patent Document 2] Japanese Laid-open Patent Publication No. 2006-165703
[Patent Document 3] Japanese Laid-open Patent Publication No. 2008-113434

### SUMMARY

According to an aspect of the embodiment, an image coding apparatus includes a coding and decoding unit configured to selectively encode and decode pictures to be used as a reference among a predetermined number of pictures based on information for discriminating between pictures to be used as a reference and pictures not to be used as a reference, followed by encoding pictures not to be used as a reference among the predetermined number of pictures, an in-loop filter configured to perform filtering with respect to the pictures decoded by the coding and decoding unit, and a control unit configured to suspend power supply to the in-loop filter in response to timing at which the coding and decoding unit encodes the pictures not to be used as a reference.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the configuration of an image coding apparatus;

FIG. 2 is a drawing illustrating an example of an input stream supplied to and written to a frame memory;

FIG. 3 is a drawing illustrating an example of the operation of the image coding apparatus;

FIGS. 4A and 4B are drawings illustrating comparison between an operation of a related-art image coding apparatus and an operation of the image coding apparatus of FIG. 1;

FIG. 5 is a drawing for explaining an effect of power gating on reducing energy consumption caused by leakage;

FIGS. 6A and 6B are drawings illustrating differences in the reduction of power consumption provided by different image coding apparatuses;

FIG. 7 is a flowchart illustrating an example of the operation of an overall control unit;

FIGS. 8A and 8B are drawings illustrating examples of memory bank information;

FIG. 9 is a drawing illustrating an example of the configuration of GOP information;

FIG. 10 is a flowchart illustrating an example of the operation of a coding and decoding unit;

FIG. 11 is a flowchart illustrating an example of the processing of a picture performed by the coding and decoding unit;

FIGS. 12A and 12B are drawings illustrating examples of the configuration of an in-loop filter;

FIG. 13 is a drawing illustrating the configuration of a coded stream output from an entropy-coding unit; and

FIG. 14 is a drawing illustrating an example of the configuration of a digital camera to which the image coding apparatus of FIG. 1 is applied.

### DESCRIPTION OF EMBODIMENTS

In the following, embodiments of the invention will be described with reference to the accompanying drawings. In these drawings, the same or corresponding elements are referred to by the same or corresponding numerals, and a description thereof will be omitted as appropriate.

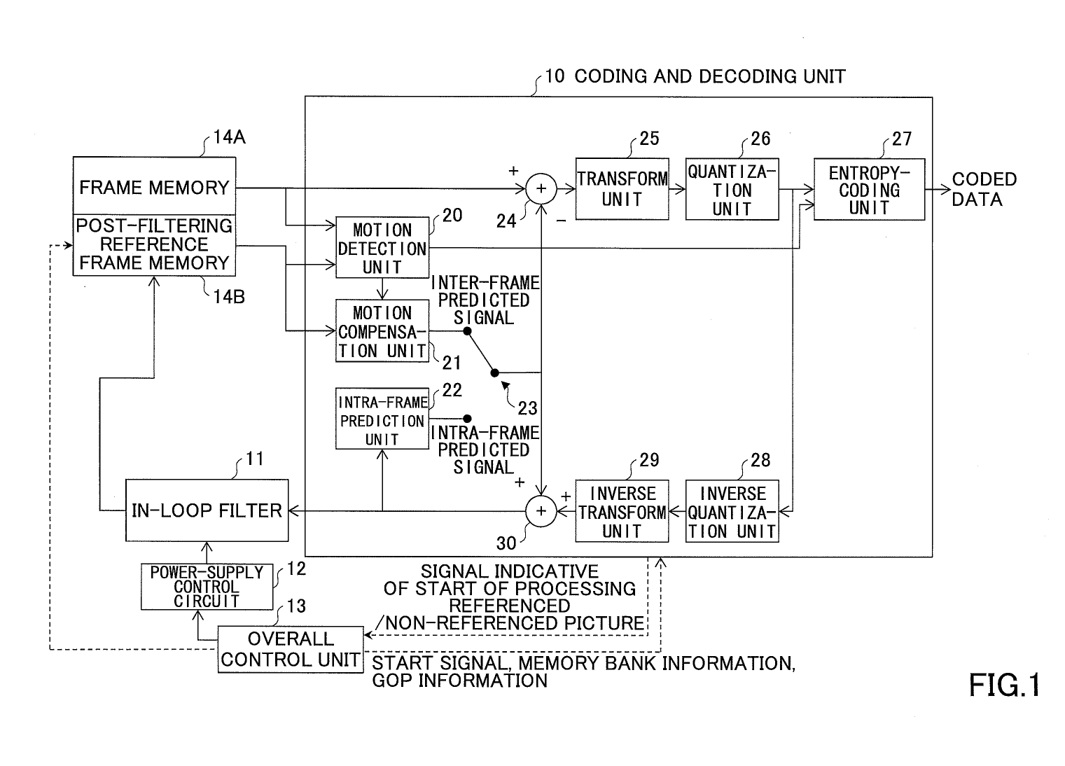

FIG. 1 is a drawing illustrating an example of the configuration of an image coding apparatus. In FIG. 1, boundaries between functional blocks illustrated as boxes basically indicate functional boundaries, and may not correspond to separation in terms of physical positions, separation in terms of electrical signals, separation in terms of control logic, etc. The image coding apparatus may have a hardware configuration implemented by combining electronic circuit blocks having the functions of respective functional blocks, or may have a software configuration in which the functions of respective functional blocks are implemented by software executed by a general-purpose processor that is an electronic circuit. In the case of hardware implementation, each functional block may be a hardware module that is physically separated from other blocks to some extent, or may indicate a function in a hardware module in which this and other blocks are physically combined together. In the case of software implementation, each functional block may be a software module that is logically separated from other blocks to some extent, or may indicate a function in a software module in which this and other blocks are logically combined together.

The image coding apparatus includes a coding and decoding unit 10, an in-loop filter 11, a power-supply control circuit 12, and an overall control unit 13. The image coding apparatus is connected to a frame memory 14A and a post-filtering reference frame memory 14B, and encodes picture data retrieved from the frame memory 14A to output coded data. In this coding process, the image coding apparatus uses a reference picture stored in the post-filtering reference frame memory 14B. Specifically, a motion vector of a block of interest in a picture subjected to coding is calculated with respect to a reference picture. The picture block in the reference picture that is situated at the position corresponding to the optimum detected motion vector is used as a predicted picture. Differentials between the predicted picture and the block of interest are calculated so as to reduce the amount of data subjected to coding.

A picture coded by the coding and decoding unit 10 is decoded in the coding and decoding unit 10, and the decoded picture is stored in the post-filtering reference frame memory 14B through the in-loop filter 11. An image decoding apparatus that decodes the coded data output from the image coding apparatus uses a reference picture in the decoding process. This reference picture is generated by decoding the coded data received from the image coding apparatus. In order to provide the same conditions as in the image decoding apparatus, the reference picture used in the image coding apparatus is not an original picture in the input stream, but is a picture that is obtained by decoding the picture that has been coded. The in-loop filter 11 performs filtering with respect to a picture decoded by the coding and decoding unit 10. This filtering process performs a deblocking filter process and the like that averages the values of neighboring pixels on both sides of a block boundary to reduce edge artifacts having a block shape appearing at the block boundaries.

The coding and decoding unit 10 includes a motion detection unit 20, a motion compensation unit 21, an intra-frame prediction unit 22, a selecting unit 23, a prediction-error calculating unit 24, a transform unit 25, a quantization unit 26, an entropy-coding unit 27, an inverse quantization unit 28, an inverse transform unit 29, and an addition unit 30. The frame memory 14A stores therein pictures of the most recent several frames among the moving picture data successively supplied from an external moving picture source such as a video camera. The coding and decoding unit 10 retrieves a picture subjected to coding from the frame memory 14A, and encodes the retrieved picture. The picture subjected to coding is divided into a plurality of macroblocks, one of which is a macroblock of interest that is subjected to coding.

The motion detection unit 20 and the motion compensation unit 21 generate an inter-frame predicted picture from a reference picture and the macroblock of interest in the picture subjected to coding. The intra-frame prediction unit 22 generates an intra-frame predicted picture from the picture data of the picture subjected to coding to which the macroblock of interest belongs, i.e., from the picture data of the same frame as the frame to which the macroblock of interest belongs. The selecting unit 23 selects either the intra-frame prediction method (i.e., intra prediction method) or the inter-frame prediction method (i.e., inter prediction method) as the method of generating a predicted picture for each macroblock. The reference picture is retrieved from the post-filtering reference frame memory 14B.

To be more specific, the process by the motion detection unit 20 obtains, with respect to each of a plurality of motion vectors, an error (e.g., the sum of absolute values of pixel-by-pixel differentials) between the macroblock of interest and a picture block at the corresponding position in the reference picture, and finds an optimum motion vector in view of the sizes of the obtained errors. Selecting a motion vector ensuring that the predicted picture is the closest to the macroblock of interest results in the amount of information of an error picture being the smallest. It follows that the amount of information of a bit stream ultimately obtained upon coding is the smallest. The motion compensation unit 21 extracts a picture block in the reference picture at the position corresponding to the detected optimum motion vector, and outputs the extracted picture block as a predicted picture.

The predicted picture selected by the selecting unit 23 is supplied to the prediction-error calculating unit 24. The prediction-error calculating unit 24 calculates differences between the predicted picture and the block of interest to derive an error picture from the predicted picture and the block of interest, followed by supplying the error picture to the transform unit 25. The transform unit 25 performs an orthogonal transformation with respect to the error picture. The quantization unit 26 performs quantization with respect to the orthogonally-transformed error picture, i.e., with respect to the transform coefficients thereof, thereby deriving the quantized transform coefficients. The quantized transform coefficients are supplied to the entropy-coding unit 27 and to the inverse quantization unit 28. The entropy-coding unit 27 performs entropy coding with respect to the quantized transform coefficients to generate coded data (i.e., bit stream) that is picture information having a reduced amount of information. The motion vector detected by the motion detection unit 20 is entropy-coded together with the quantized transform coefficients, so that the bit stream contains information about the motion vector.

The inverse quantization unit 28 performs inverse quantization with respect to the quantized transform coefficients to restore the transform coefficients. The inverse transform unit 29 performs inverse orthogonal transformation with respect to the transform coefficients to restore the error picture. The addition unit 30 generates a reconstructed picture from the restored error picture and the predicted picture used by the prediction-error calculating unit 24. The in-loop filter 11 performs a deblocking filter process and the like that reduces block artifacts appearing in the reconstructed picture due to the orthogonal transformation, the quantization, the inverse quantization, and the inverse-orthogonal transformation. The local decode picture that is obtained by the filtering process is stored in the post-filtering reference frame memory 14B.

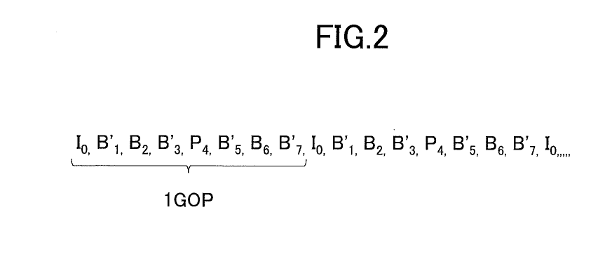

FIG. 2 is a drawing illustrating an example of an input stream supplied to and written to the frame memory 14A. As illustrated in FIG. 2, pictures are sequentially supplied to and stored in the frame memory 14A as an input stream in the following order: an I picture I₀, a B picture B′₁, a B picture B₂, a B picture B′₃, a P picture P₄, . . . , for example. The I picture (intra picture) is coded, within the current frame, independently of preceding or following frames, and the coding thereof is performed solely by use of information within the frame without performing motion prediction in the time dimension. The P picture (predictive picture) is coded by performing forward prediction between frames, and the coding thereof is performed by use of inter-frame prediction based on either an I picture of a P picture that serves as the predicted picture. The independent decoding of the P picture is not possible. The B picture (bi-directional predictive picture) is subjected to predictive coding in both directions, i.e., the forward direction from the past and the backward direction from the future. Prediction for the B picture is performed by use of an I picture, a P picture, or a B picture as predicted pictures, which are situated in the time dimension in the past, in the future, or in both the past and the future, relative to the picture subjected to processing. The independent decoding of the B picture is also not possible. In the case of the B picture, improvement in compression efficiency is attainable compared with the I or P picture.

GOP (i.e., group of picture) is a set of pictures that serves as a unit of compression coding. GOP includes at least one I picture, and may include one or more P pictures and one or more B pictures. In the example illustrated in FIG. 2, GOP includes one I picture, one P picture, and 6 B pictures. Each picture in GOP is identified by a sequence number that ranges from 0 to 7.

In FIG. 2, a picture that is used as a reference in the coding process (such a picture will hereinafter be referred to as a referenced picture) is indicated by an alphabet without the prime symbol (′). A picture that is not used as a reference in the coding process (such a picture will hereinafter be referred to as a non-referenced picture) is indicated by an alphabet with the prime symbol (′). In the example illustrated in FIG. 2, the B picture B′₁, the B picture B′₃, the B picture B′₅, and the B picture B′₇ are those pictures which are not used as a reference in the coding process. Namely, these pictures are not used as a reference picture when coding another picture, and thus need not to be stored in the post-filtering reference frame memory 14B. The remaining pictures, i.e., the I picture I₀, the B picture B₂, the P picture P₄, and the B picture B₆ are used as a reference in the coding process. Namely, these pictures are used as a reference picture when coding another picture, and may thus need to be stored in the post-filtering reference frame memory 14B.

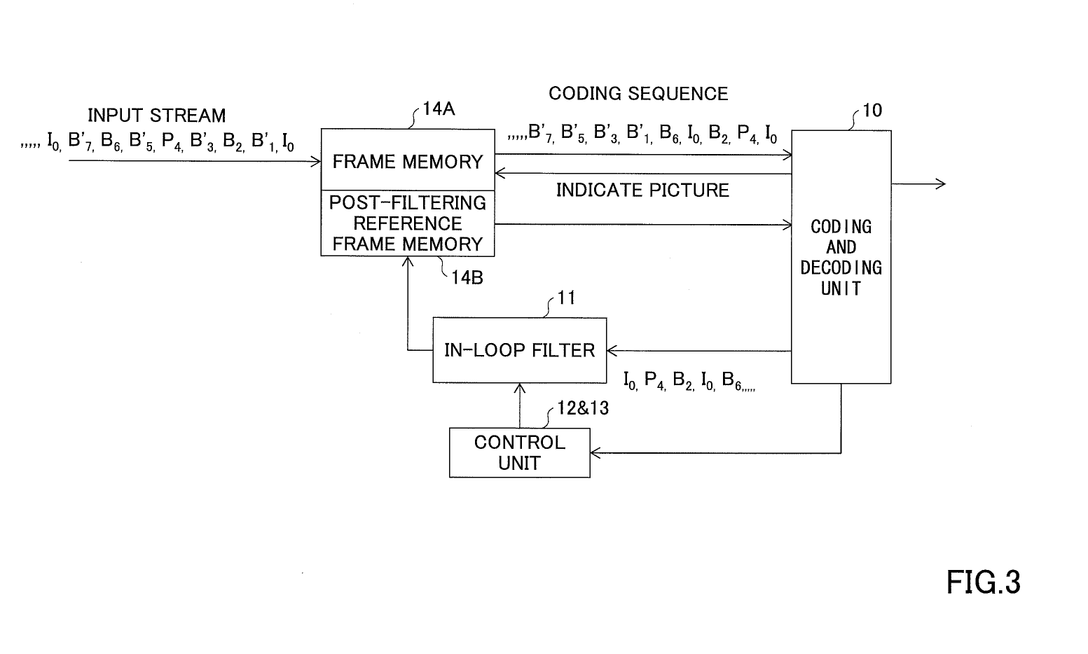

FIG. 3 is a drawing illustrating an example of the operation of the image coding apparatus. In FIG. 3, the same or corresponding elements as those of FIG. 1 are referred to by the same or corresponding numerals, and a description thereof will be omitted as appropriate. In FIG. 3, the power-supply control circuit 12 and the overall control unit 13 illustrated in FIG. 1 are illustrated as a single control unit 12&13. The stream input into the frame memory 14A is the same as the stream illustrated in FIG. 2.

The coding and decoding unit 10 supplies to the frame memory 14A a signal indicative of a picture for retrieval (e.g., an address signal or a signal indicating a bank and a picture ID) to retrieve an indicated picture from the frame memory 14A. In so doing, utilizing information for discriminating between pictures to be used as a reference and pictures not to be used as a reference, the coding and decoding unit 10 first selectively encodes and decodes the one or more pictures that are to be used as a reference among a predetermined number of pictures. Thereafter, the coding and decoding unit 10 encodes the pictures that are not to be used as a reference among the predetermined number of pictures. In the example illustrated in FIG. 3, the predetermined number of pictures are pictures equal in number to the pictures included in one GOP. GOP of this example includes 8 pictures, so that the predetermined number is eight. The predetermined number does not have to be equal to the number of pictures of GOP.

As illustrated in FIG. 3, the sequence of pictures are I₀, B₁′, B₂, B₃′, P₄, B₅′, B₆, B₇′, I₀, and so on in the stream that is input into and stored in the frame memory 14A. On the other hand, the coding and decoding unit 10 retrieves pictures from the frame memory 14A in a sequence that is different from the sequence of pictures of the input stream. The coding and decoding unit 10 first retrieves the I picture I₀ that is the head end (0-th) of the input stream. After that, the coding and decoding unit 10 selectively retrieves P₄, B₂, I₀, and B₆ that are the pictures to be referenced among the 8 pictures from the first picture of the first GOP to the zeroth picture of the second GOP. This reading sequence will be described later. The coding and decoding unit 10 successively encodes and decodes these retrieved pictures.

After that, the coding and decoding unit 10 selectively retrieves B′₁, B′₃, B′₅, and B′₇ that are the pictures to be not referenced among the 8 pictures from the first picture of the first GOP to the zeroth picture of the second GOP. The coding and decoding unit 10 successively encodes these retrieved pictures. Since these pictures are not referenced, there is no need to decode these pictures. Nonetheless, the coding and decoding unit 10 may still decode these pictures. Regardless of whether to perform decoding, a picture that is not referenced does not have to be stored in the post-filtering reference frame memory 14B as was previously described.

The control unit 12&13 suspends power supply to the in-loop filter 11 in response to the time at which the coding and decoding unit 10 encodes the pictures that are not referenced. As described above, the pictures that are not referenced do not have to be stored in the post-filtering reference frame memory 14B, and do not have to be processed by the in-loop filter 11. During the period in which the coding and decoding unit 10 encodes a series of pictures that are not referenced, therefore, there is no need for the in-loop filter 11 to be operating. More strictly speaking, there is no need for the in-loop filter 11 to be operating until the time a series of pictures to be referenced following the series of pictures to be not referenced are coded and decoded so as to require the in-loop filtering process to be performed thereon. During an ongoing stream, thereafter, there is no need for an in-loop filtering process after the completion of in-loop filtering of a series of coded and decoded pictures to be referenced and before the commencement of in-loop filtering of a next series of coded and decoded pictures to be referenced. Power supply to the in-loop filter 11 may thus be suspended by use of the control unit (i.e., the power-supply control circuit 12 and the overall control unit 13) during the period in which the in-loop filtering process is not needed. This arrangement serves to reduce power consumption.

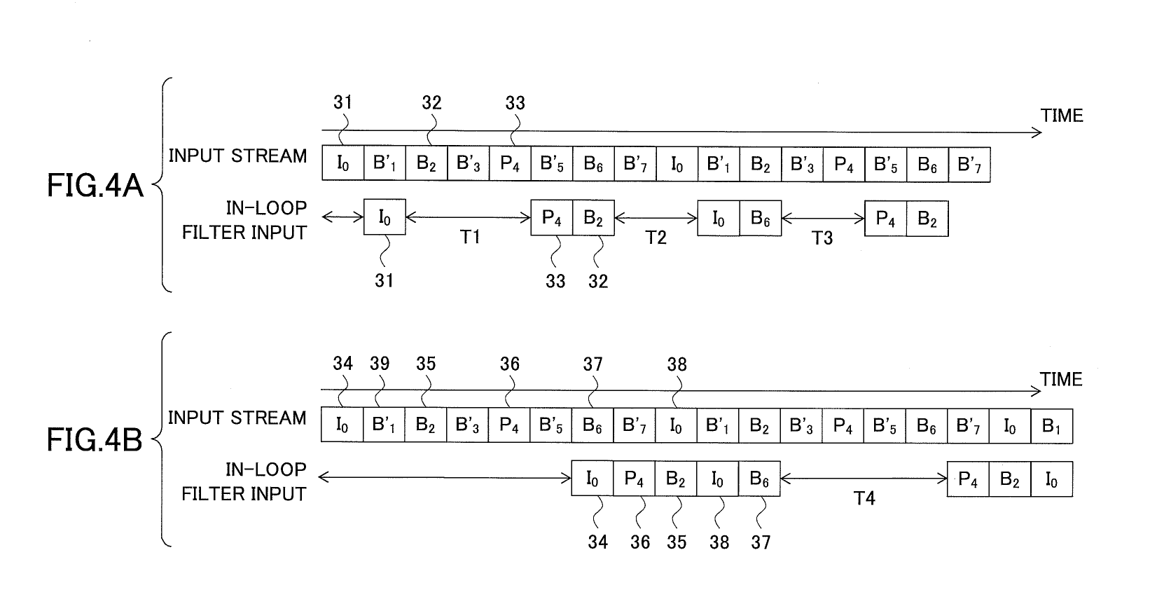

FIGS. 4A and 4B are drawings illustrating comparison between an operation of a related-art image coding apparatus and an operation of the image coding apparatus of FIG. 1. FIG. 4A illustrates on the upper row an input stream that is stored in the frame memory in the case of a related-art image coding apparatus. This input stream is the same as the stream illustrated in FIG. 2. FIG. 4A also illustrates on the lower row the sequence and retrieval time of pictures that are to be referenced and that the related-art image coding apparatus retrieves from the frame memory and inputs into the in-loop filter. FIG. 4A illustrates only the pictures that are input into the in-loop filter, and do not illustrate the remaining pictures that are not to be referenced.

The related-art image coding apparatus retrieves a picture from the frame memory immediately upon becoming able to process this picture. In the example illustrated in FIG. 4A, the I picture I₀ 31 that is independently coded can be processed immediately upon being stored in the frame memory, so that this picture is immediately retrieved from the frame memory. The succeeding B pictures require reference pictures both in the past and in the future, and are thus not possible to be processed. These pictures are thus not immediately retrieved from the frame memory. A P picture P₄ 33 situated thereafter has a reference picture thereof (i.e., I₀ in this case) in the past that has already been processed, so that this P picture is possible to be processed immediately upon being stored in the frame memory. This P picture is thus immediately retrieved from the frame memory. At this point in time, the B picture B₂ 32 becomes possible to be processed, and is thus retrieved immediately after the retrieval of the P picture P₄ 33. Similar operations follow thereafter.

In FIG. 4A, the in-loop filtering process is not needed during periods T1, T2 and T3 that come between the retrievals of pictures that are to be referenced. Power supply to the in-loop filter 11 may be suspended during these periods T1, T2 and T3. Since each of the periods T1, T2 and T3 is relatively short, however, sufficient reduction in power consumption is not attainable.

FIG. 4B illustrates on the upper row an input stream that is stored in the frame memory in the case of the image coding apparatus illustrated in FIG. 1. This input stream is the same as the stream illustrated in FIG. 2. FIG. 4B also illustrates on the lower row the sequence and retrieval time of pictures that are to be referenced and that the image coding apparatus of FIG. 1 retrieves from the frame memory and inputs into the in-loop filter. FIG. 4B illustrates only the pictures that are input into the in-loop filter, and do not illustrate the remaining pictures that are not to be referenced.

The image coding apparatus illustrated in FIG. 1 first selectively retrieves the pictures that are to be referenced among a predetermined number of pictures. In the example illustrated in FIG. 4B, P₄ 36, B₂ 35, I₀ 38, and B₆ 37 that are all the pictures to be referenced among the 8 pictures from the first picture B′₁ 39 of the first GOP to the zeroth picture I₀ 38 of the second GOP are selectively retrieved in this sequence continuously in a single batch. In so doing, these four pictures are retrieved from the frame memory at such timing that the I picture I₀ 38 of the second GOP arriving the last among these four pictures is retrieved from the frame memory immediately upon this I picture being stored in the frame memory. It may be noted that I₀ 34 at the head end of the input stream is also retrieved at the same time as the retrieval of these four pictures. Because of the adding of the head-end picture I₀ 34, a total of five pictures are retrieved in a single batch the first time. At later stages in the stream, only the four pictures P₄ 36, B₂ 35, I₀ 38, and B₆ 37 that are to be referenced are selectively retrieved in a single batch in a recursive manner.

In the example illustrated in FIG. 4B, the sequence in which pictures are retrieved from the frame memory is such that a picture possible to be coded that was stored earliest in the frame memory is retrieved first. Specifically, the I picture I₀ 34 that is possible to be coded is the earliest one to have been stored in the frame memory, and, thus, is retrieved first from the frame memory. The succeeding B picture B₂ 35 requires reference pictures both in the past and in the future, and is thus not possible to be processed. This picture is thus not immediately retrieved from the frame memory after I₀ 34. A P picture P₄ 36 situated thereafter has a reference picture thereof (i.e., I₀ 34 in this case) in the past that has already been processed, so that this P picture is possible to be processed and retrieved from the frame memory immediately after I₀ 34. At this point in time, the B picture B₂ 35 becomes possible to be processed, and is thus retrieved immediately after the retrieval of the P picture P₄ 36. Similar operations follow thereafter.

In FIG. 4B, the in-loop filtering process is not needed during a period T4 that comes between the retrievals of pictures that are to be referenced. Power supply to the in-loop filter 11 may be suspended during the period T4. In this case, the period T4 is sufficiently long compared with the periods T1, T2 and T3 illustrated in FIG. 4A, thereby bringing about a sufficient reduction in power consumption.

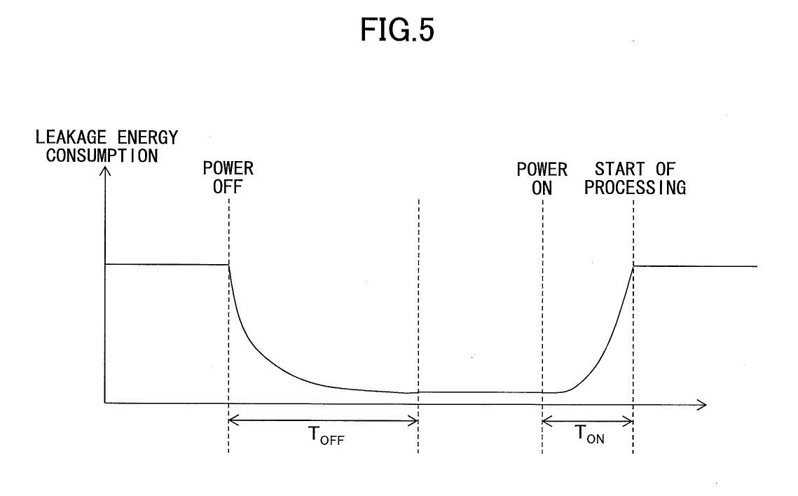

FIG. 5 is a drawing for explaining an effect of power gating on reducing energy consumption caused by leakage. In FIG. 5, the horizontal axis represents time, and the vertical axis represents energy consumption in a circuit caused by current leakage. As illustrated in FIG. 5, suspension of power supply to the circuit by use of power gating does not result in energy consumption immediately becoming zero. Electric power continues to be consumed during a period T_{OFF}. Even after the suspension of power supply, electric charge accumulated in parasitic capacitance and the like existing in the circuit continues to discharge through current-leakage paths. The amount of leak currents thus exhibit a gradual decrease during the period T_{OFF} after the suspension of power supply. Upon resumption of power supply, processing in the circuit does not immediately become available. Waiting is necessary until the signal lines in the circuit return to respective, expected voltages, which takes a period T_{ON}. With the time length of power supply suspension being short, the time length in which a sufficient power gating effect is obtained (i.e., the period in which the leak current is nearly zero) is short. In this case, reduction in power consumption by power gating is not sufficiently effective. Further, since power is consumed for power-on and power-off operations during power gating, frequent repeating of power-on and power-off operations may cause the resultant increase in power consumption to exceed the reduction of power consumption achieved by power gating.

The image coding apparatus of FIG. 1 illustrated in FIG. 4B achieves a longer time period during which power gating suspends power supply than does the related-art image coding apparatus illustrated in FIG. 4A. In this manner, the image coding apparatus of FIG. 1 provides a larger reduction in power consumption.

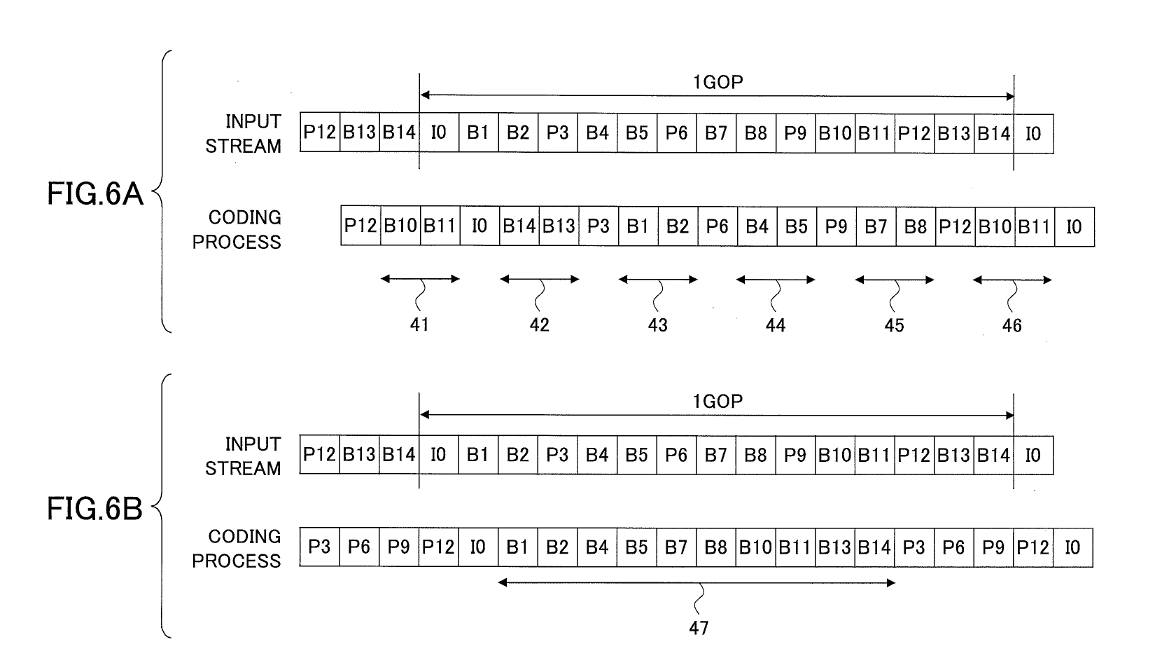

FIGS. 6A and 6B are drawings illustrating differences in the reduction of power consumption provided by different image coding apparatuses. FIG. 6A illustrates on the upper row an input stream that is stored in the frame memory in the case of a related-art image coding apparatus. A GOP consisting of 15 pictures is repeated in this input stream. Among the 15 pictures of one GOP, all the pictures except for the B pictures are referenced, and all the B pictures are not referenced. FIG. 6A illustrates on the lower row the sequence and retrieval timing of pictures that the related-art image coding apparatus retrieves from the frame memory. FIG. 6A further illustrates periods 41 through 46 during which the B pictures that are not referenced are retrieved. During these periods 41 through 46, power supply to the in-loop filter may be suspended to reduce power consumption. In this example, the number of occurrences of powering on the in-loop filter in the processing of one GOP is 5, and the number of occurrences of powering off the in-loop filter is 5. With T indicating the time length required for processing one picture, the total length of the power-suspended periods is expressed as 10T.

FIG. 6B illustrates on the upper row an input stream that is stored in the frame memory in the case of the image coding apparatus illustrated in FIG. 1. This input stream is the same as the stream illustrated in FIG. 6A. FIG. 6A illustrates on the lower row the sequence and retrieval timing of pictures that the image coding apparatus of FIG. 1 retrieves from the frame memory. FIG. 6B further illustrates a period 47 during which the B pictures that are not referenced are retrieved. During this period 47, power supply to the in-loop filter may be suspended to reduce power consumption. In this example, the number of occurrences of powering on in the processing of one GOP is 1, and the number of occurrences of powering off is 1. The total length of the power-suspended period is 10T, which is the same as in the related art.

The time length required to reach the state of low current leakage upon power suspension is denoted as T_{OFF}, and the startup time that passes from the power-on to the time by which processing becomes possible is denoted as T_{ON}. The time length during which the in-loop filter circuit is in the state of low current leakage in the case of the related art is 10T-(5T_{OFF}+5T_{ON}). In contrast, the time length during which the in-loop filter circuit of the image coding apparatus illustrated in FIG. 1 is in the state of low current leakage is 10T-(T_{OFF}+T_{ON}). The time length of the state of low current leakage is thus increased compared with the related-art configuration. A switch circuit (i.e., power-supply control circuit) that turns on and off power supply to the in-loop filter may have a capacitor with a capacitance value denoted as C, and may receive a power supply voltage denoted as V. In this case, energy consumption of a single-time occurrence of power-on and power-off is 1/2CV². Since the number of occurrences of power-on and power-off is smaller in the image coding apparatus of FIG. 1 than in the related-art configuration, energy consumption by the power-supply control circuit is also reduced compared with the case of the related-art configuration.

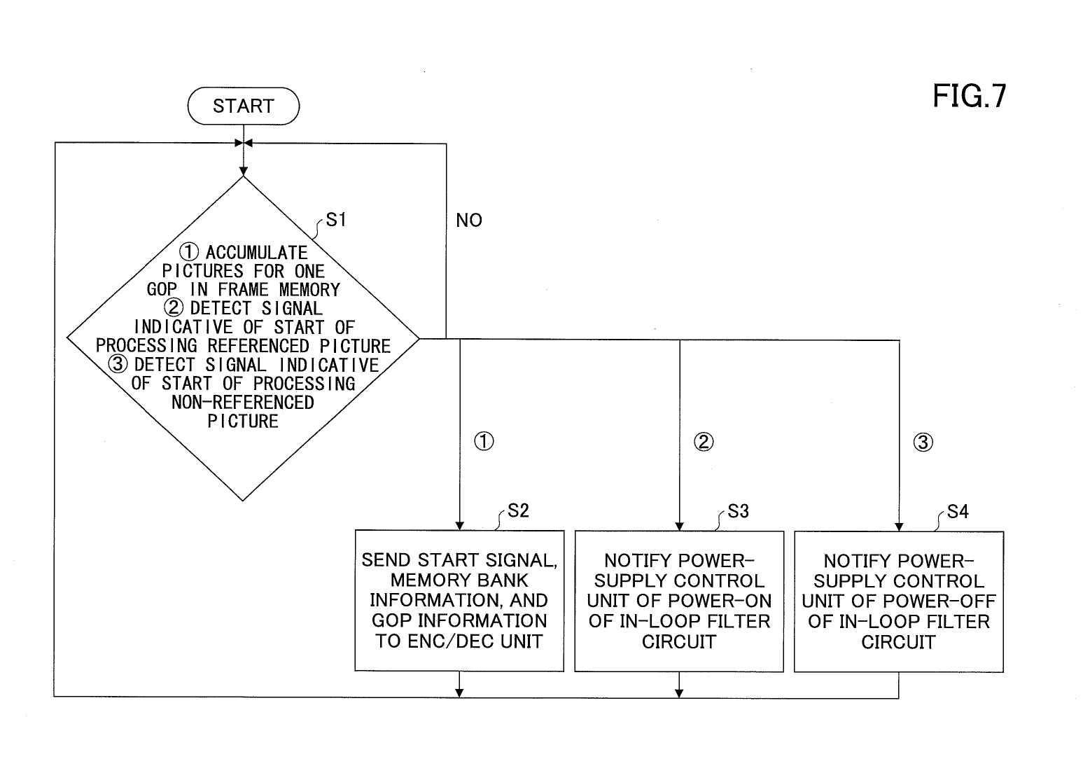

FIG. 7 is a flowchart illustrating an example of the operation of the overall control unit 13. The operation of the overall control unit 13 illustrated in FIG. 1 will be described with reference to FIG. 7.

In step S1, the overall control unit 13 checks whether the pictures for one GOP are stored in the frame memory 14A. In the case of the check result indicating “NO”, the procedure goes back to step S1. In the case of the check result indicating “YES”, the procedure proceeds to step S2, in which the overall control unit 13 supplies the start signal, the memory bank information and the GOP information to the coding and decoding unit 10. In response to the start signal, the coding and decoding unit 10 starts retrieving pictures from the frame memory, and starts the operation of coding and decoding the pictures, as will be described later. During the retrieval of pictures from the frame memory and the coding and decoding of the pictures, the coding and decoding unit 10 refers to the GOP information. After step S2, the procedure goes back to step S1.

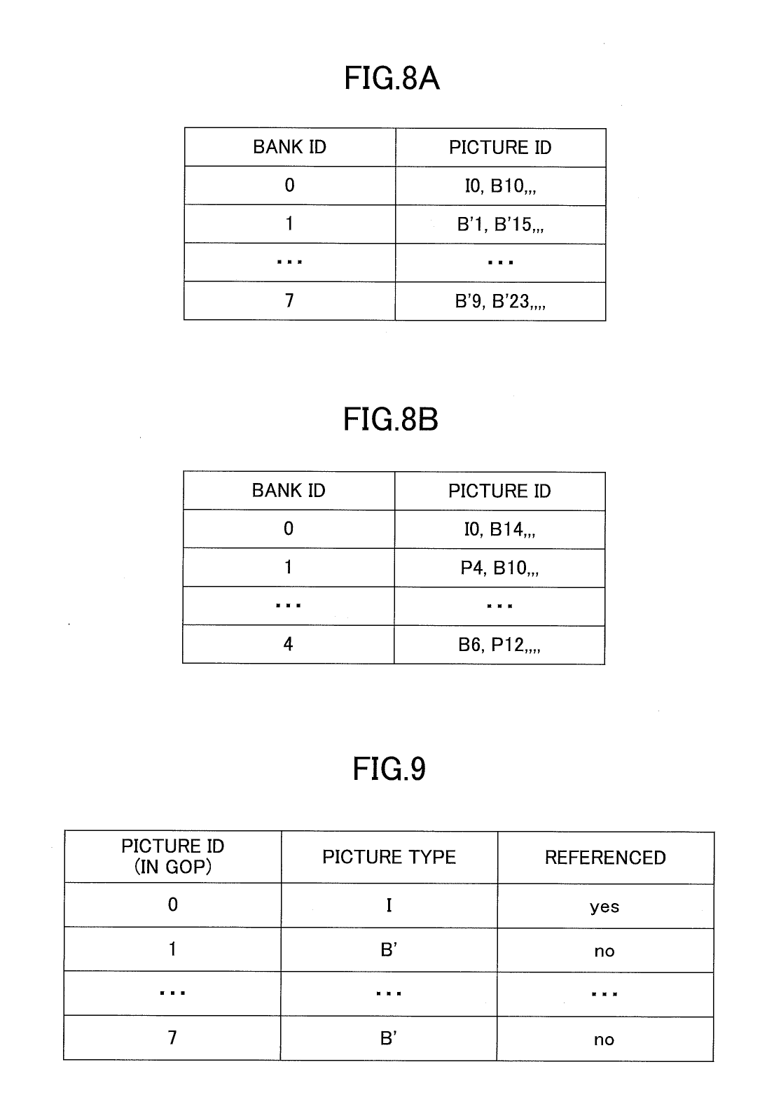

FIGS. 8A and 8B are drawings illustrating examples of memory bank information. FIG. 8A illustrates the memory bank information of the frame memory 14A. FIG. 8B illustrates the memory bank information of the post-filtering reference frame memory 14B. As illustrated in FIG. 8A and FIG. 8B, the memory bank information identifies pictures stored in a bank by use of the picture IDs thereof for each of the banks that are included in the frame memory and identified by the bank IDs.

FIG. 9 is a drawing illustrating an example of the configuration of GOP information. As illustrated in FIG. 9, for each of the pictures that belong to the GOP of interest and identified by picture IDs, the GOP information contains information indicative of a picture type (i.e., information identifying at least one of the I type, the P type, and the B type) and information indicative of whether the given picture is to be referenced.

By referring to FIG. 7 again, the overall control unit 13 checks in step S1 whether the signal for starting the processing of a picture to be referenced (i.e., the signal indicative of start of processing a referenced picture) is detected. As will be described later, the signal indicative of start of processing a referenced picture is supplied from the coding and decoding unit 10 to the overall control unit 13. In the case of the check result indicating “NO”, the procedure goes back to step S1. In the case of the check result indicating “YES”, the procedure proceeds to step S3, in which the overall control unit 13 sends a request to the power-supply control circuit 12 to power on the in-loop filter 11. In response to the request, the power-supply control circuit 12 starts supplying power to the in-loop filter 11. In this manner, the power-supply control circuit 12 and the overall control unit 13 start supplying power to the in-loop filter 11 in response to the signal indicative of start of coding and decoding of a picture to be referenced by the coding and decoding unit 10. After step S2, the procedure goes back to step S1.

The overall control unit 13 checks in step S1 whether the signal for starting the processing of a picture to be not referenced (i.e., the signal indicative of start of processing a non-referenced picture) is detected. As will be described later, the signal indicative of start of processing a non-referenced picture is supplied from the coding and decoding unit 10 to the overall control unit 13. In the case of the check result indicating “NO”, the procedure goes back to step S1. In the case of the check result indicating “YES”, the procedure proceeds to step S3, in which the overall control unit 13 sends a request to the power-supply control circuit 12 to power off the in-loop filter 11. In response to the request, the power-supply control circuit 12 stops supplying power to the in-loop filter 11. After step S2, the procedure goes back to step S1. In this manner, the power-supply control circuit 12 and the overall control unit 13 stop supplying power to the in-loop filter 11 in response to the signal indicative of start of coding of a picture to be not referenced by the coding and decoding unit 10.

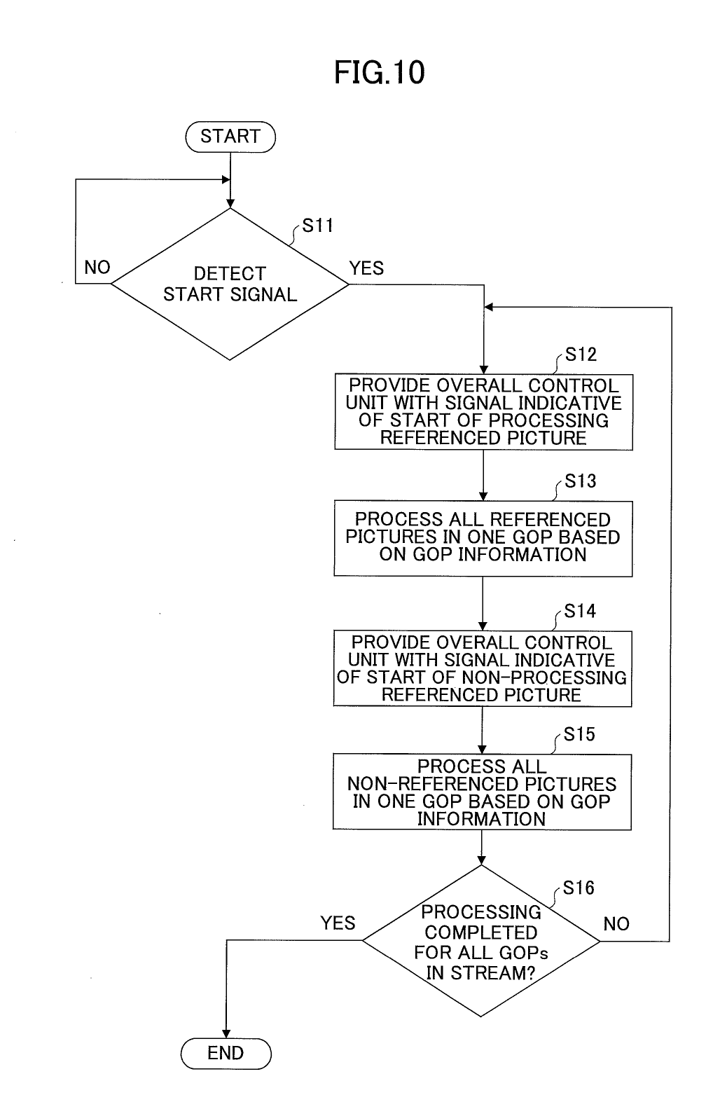

FIG. 10 is a flowchart illustrating an example of the operation of the coding and decoding unit 10. The operation of the coding and decoding unit 10 illustrated in FIG. 1 will be described with reference to FIG. 10. It may be noted that, in FIG. 10 and the subsequent flowcharts, an order in which the steps illustrated in the flowchart are performed is only an example. The scope of the disclosed technology is not limited to the disclosed order. For example, a description may explain that an A step is performed before a B step is performed. Despite such a description, it may be physically and logically possible to perform the B step before the A step while it is possible to perform the A step before the B step. In such a case, all the consequences that affect the outcomes of the flowchart may be the same regardless of which step is performed first. It then follows that, for the purposes of the disclosed technology, it is apparent that the B step can be performed before the A step is performed. Despite the explanation that the A step is performed before the B step, such a description is not intended to place the obvious case as described above outside the scope of the disclosed technology. Such an obvious case inevitably falls within the scope of the technology intended by this disclosure.

In step S11 of FIG. 10, the coding and decoding unit 10 checks whether the start signal from the overall control unit 13 is detected. The check operation is repeated until the start signal is detected. Upon the detection of the start signal, the procedure proceeds to step S12. In step S12, the coding and decoding unit 10 supplies the signal indicative of start of processing a referenced picture to the overall control unit 13. With this arrangement, the coding and decoding unit 10 notifies the overall control unit 13 that the coding and decoding of referenced pictures has started. In step S13, the coding and decoding unit 10 uses the GOP information to select pictures to be referenced in the GOP of interest, followed by retrieving the selected pictures from the frame memory 14A. Namely, the coding and decoding unit 10 identifies the pictures for which the information indicative of “REFERENCED” is “yes” in the GOP information illustrated in FIG. 9, and retrieves the identified pictures from the frame memory 14A. The coding and decoding unit 10 successively encodes and decodes the retrieved pictures.

In step S14, the coding and decoding unit 10 supplies the signal indicative of start of processing a non-referenced picture to the overall control unit 13. With this arrangement, the coding and decoding unit 10 notifies the overall control unit 13 that the coding of non-referenced pictures has started. In step S15, the coding and decoding unit 10 uses the GOP information to select pictures to be not referenced in the GOP of interest, followed by retrieving the selected pictures from the frame memory 14A. Namely, the coding and decoding unit 10 identifies the pictures for which the information indicative of “REFERENCED” is “no” in the GOP information illustrated in FIG. 9, and retrieves the identified pictures from the frame memory 14A. The coding and decoding unit 10 successively encodes the retrieved pictures.

In step S16, the coding and decoding unit 10 checks whether processing is completed with respect to all the GOPs included in the stream. In the case of the check result being “NO”, the procedure goes back to step S12 to repeat the subsequent processes. In the case of the check result being “YES”, the procedure comes to an end.

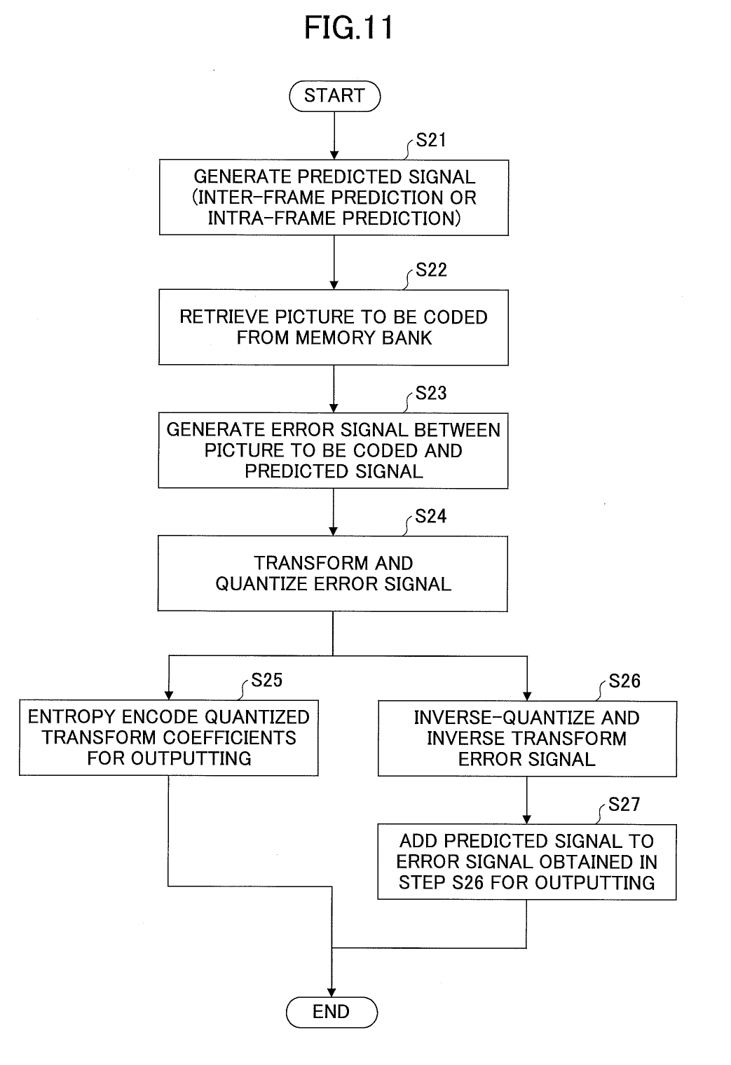

FIG. 11 is a flowchart illustrating an example of the processing of a picture performed by the coding and decoding unit 10. The operation of the coding and decoding unit 10 illustrated in FIG. 1 will be described with reference to FIG. 11.

In step S21, the motion compensation unit 21 and the intra-frame prediction unit 22 generate a predicted signal. In step S22, the coding and decoding unit 10 retrieves a picture to be coded from the relevant memory bank of the frame memory 14A. In step S23, the prediction-error calculating unit 24 generates an error signal between the picture to be coded and the predicted signal. In step S24, the transform unit 25 transforms the error signal, and the quantization unit 26 quantizes the transformed signal (i.e., the transform coefficients). In step S25, the entropy-coding unit 27 performs entropy coding with respect to the quantized transform coefficients to output the results as the output signal of the coding and decoding unit 10.

In step S26, the inverse quantization unit 28 inverse-quantizes (dequantizes) the quantized transform coefficients, and the inverse transform unit 29 performs inverse-transform with respect to the dequantized transform coefficients to obtain an error signal. In step S27, the error signal obtained in step S26 and the predicted signal obtained in step S21 are added together to reconstruct the picture, which is then output from the coding and decoding unit 10 as an input signal into the in-loop filter 11.

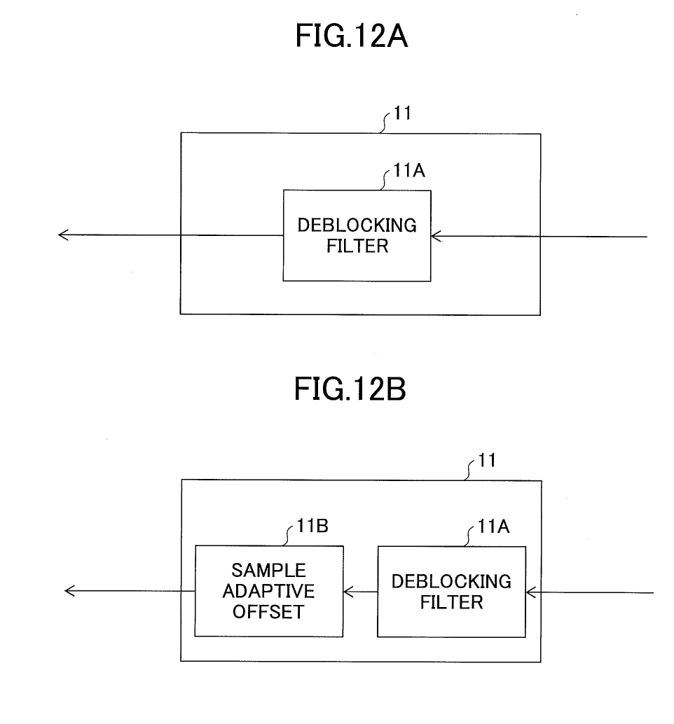

FIGS. 12A and 12B are drawings illustrating examples of the configuration of the in-loop filter 11. The in-loop filter 11 illustrated in FIG. 12A includes a deblocking filter 11A. With respect to edge artifacts having a block shape that appear due to noise generated at block boundaries, the deblocking filter 11A averages the values of neighboring pixels on both sides of an edge artifact, thereby making the edge artifacts less noticeable. The in-loop filter 11 having this configuration is used in H.264.

The in-loop filter 11 illustrated in FIG. 12B includes a deblocking filter 11A and a sample adaptive offset 11B. With respect to edge artifacts having a block shape that appear due to noise generated at block boundaries, the deblocking filter 11A averages the values of neighboring pixels on both sides of an edge artifact, thereby making the edge artifacts less noticeable. The sample adaptive offset 11B classifies reconstructed pixels into different categories, and adds an offset to the pixels in each category so as to reduce the artifacts.

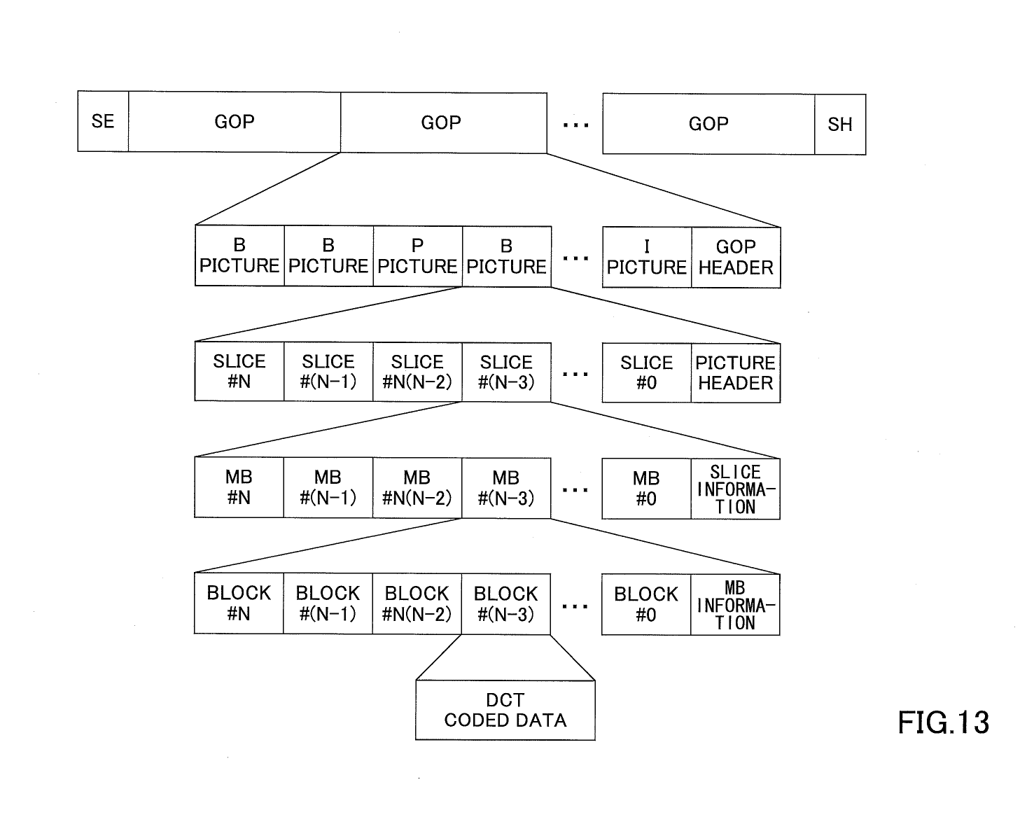

FIG. 13 is a drawing illustrating the configuration of a coded stream output from the entropy-coding unit 27. The coded stream has a sequence header SH that includes information regarding the size of pictures, the number of coded frames per second, communication speed, etc. A plurality of GOPs follow the sequence header SH. Each GOP includes pictures such as an I picture, a P picture and a B picture, and also includes a GOP header. The GOP header includes information for aligning the timing of images with the timing of voices and the like at the time of image reconstruction, for example. The GOP information illustrated in FIG. 9 is also included in this GOP header. It may be noted that this GOP information reflects the sequential arrangement of pictures in the coded stream. Each picture includes a picture header and a plurality of slices. Each slice includes slice information and a plurality of macroblocks MB. The slice information includes information about coding used in the slices and quantization characteristics. Each macroblock MB includes MB information and a plurality of blocks. The MB information includes information for controlling coding in units of macroblocks.

As described above, the coded stream transmitted to a decoding apparatus includes the GOP information illustrated in FIG. 9 Because of this, correct decoding is performed on the decoder side despite the fact that pictures are coded and arranged in the coded stream in a different sequence than the related-art configuration. Namely, the decoder side is allowed to employ a conventional decoding apparatus without any change.

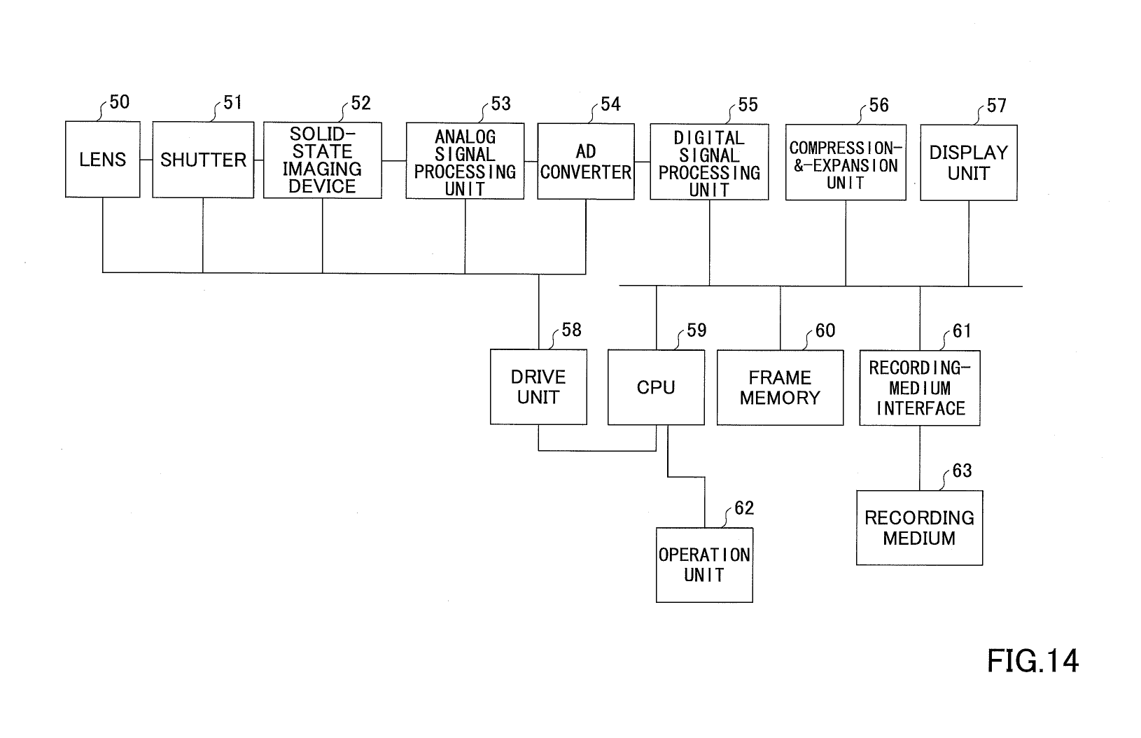

FIG. 14 is a drawing illustrating an example of the configuration of a digital camera to which the image coding apparatus of FIG. 1 is applied. The digital camera of FIG. 14 includes a lens 50, a shutter 51, a solid-state imaging device 52, an analog signal processing unit 53, an AD converter 54, a digital signal processing unit 55, a compression-&-expansion unit 56, and a display unit 57. The digital camera further includes a drive unit 58, a CPU 59, a frame memory 60, a recording-medium interface 61, and an operation unit 62. A recording medium 63 such as an SD memory card may be connected to the recording-medium interface 61.

Under the control of the CPU 59, the drive unit 58 drives the lens 50, the shutter 51, the solid-state imaging device 52, the analog signal processing unit 53 and the AD converter 54 so as to produce a digital signal representing a still image or moving pictures. The analog signal processing unit 53 performs analog processing such as correlated double sampling. The AD converter 54 converts an analog image into a digital image.

The digital signal processing unit 55 performs interpolation, white-balance correction, RGB/YC conversion, correction of color mixing, and so on with respect to the obtained digital signal. Image data after the digital signal processing are stored in the frame memory 60 The compression-&-expansion unit 56 compresses image data stored in the frame memory 60, and decompresses compressed image data. The display unit 57 displays a captured image, and also displays a menu for operations. Data of captured images are stored in the recording medium 63 through the recording-medium interface 61. The CPU 59 controls the overall operation of the digital camera.

In the digital camera illustrated in FIG. 14, the compression-&-expansion unit 56 corresponds to the image coding apparatus illustrated in FIG. 1. The use of the image coding apparatus of FIG. 1 in the digital camera illustrated in FIG. 14 enables the elongation of the operating time with respect to a predetermined level of battery charge.

According to at least one embodiment of the disclosures herein, an image coding apparatus achieves reduction in power consumption with respect to an in-loop filtering circuit by use of power gating.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An image coding apparatus, comprising:
a coding and decoding unit configured to selectively encode and decode pictures to be used as a reference among a predetermined number of pictures based on information for discriminating between pictures to be used as a reference and pictures not to be used as a reference, followed by encoding pictures not to be used as a reference among the predetermined number of pictures;
an in-loop filter configured to perform filtering with respect to the pictures decoded by the coding and decoding unit; and
a control unit configured to suspend power supply to the in-loop filter in response to timing at which the coding and decoding unit encodes the pictures not to be used as a reference.

2. The image coding apparatus as claimed in claim 1, wherein the control unit is configured to suspend power supply to the in-loop filter in response to a signal indicative of start of encoding of the pictures not to be used as a reference by the coding and decoding unit.

3. The image coding apparatus as claimed in claim 1, wherein the control unit is configured to start supplying power to the in-loop filter in response to a signal indicative of start of encoding and decoding of the pictures to be used as a reference by the coding and decoding unit.

4. The image coding apparatus as claimed in claim 1, wherein the predetermined number is equal to a number of pictures included in one GOP.

5. An image coding method, comprising:
selectively encoding and decoding pictures to be used as a reference among a predetermined number of pictures based on information for discriminating between pictures to be used as a reference and pictures not to be used as a reference;
encoding pictures not to be used as a reference among the predetermined number of pictures after selectively encoding and decoding the pictures to be used as a reference; and
suspending power supply to an in-loop filter in response to timing at which the pictures not to be used as a reference are encoded, the in-loop filter being configured to perform filtering with respect to the encoded and decoded pictures.

6. An imaging apparatus, comprising:
an imaging device;
a frame memory configured to store a stream of moving pictures captured by the imaging device; and
an image coding apparatus configured to encode the stream that is retrieved from the frame memory,
wherein the image coding apparatus includes:
a coding and decoding unit configured to selectively encode and decode pictures to be used as a reference among a predetermined number of pictures based on information for discriminating between pictures to be used as a reference and pictures not to be used as a reference, followed by encoding pictures not to be used as a reference among the predetermined number of pictures;
an in-loop filter configured to perform filtering with respect to the pictures decoded by the coding and decoding unit; and
a control unit configured to suspend power supply to the in-loop filter in response to timing at which the coding and decoding unit encodes the pictures not to be used as a reference.
